(19) United States
(12) Patent Application Publication
(10) Pub. No.: US 2026/0310320 A1
(43) Pub. Date: Oct. 8, 2026

(54) DRIVING METHOD AND APPARATUS FOR TOUCH DISPLAY PANEL AND TOUCH DISPLAY

(71) Applicant: WUHAN CHINA STAR OPTOELECTRONICS TECHNOLOGY CO., LTD., Wuhan, Hubei (CN)

(72) Inventors: Lixin ZHANG, Wuhan, Hubei (CN); Yuanmin DENG, Wuhan, Hubei (CN); Xindong MEI, Wuhan, Hubei (CN); Chao WANG, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/996,661

(22) PCT Filed: Jun. 30, 2023
(86) PCT No.: PCT/CN2023/105081

§ 371 Date: Jan. 17, 2025

(30) Foreign Application Priority Data
May 30, 2023 (CN) 202310648138.1

(51) Int. Cl. G06F 3/041

(52) U.S. Cl. CPC G06F 3/04184; G06F 3/0412; G06F 3/04164; G06F 3/04166

(57) ABSTRACT

A method and apparatus for driving a touch display panel (1), and a touch display. Disclosed is a specific implementation scheme for performing display scanning on a portion of the touch display panel (1) while synchronously conducting touch sensing on another portion, so that the touch sensing refresh rate is several times the display scanning refresh rate. Thereby, the sampling frequency and sensing speed of touch sensing are increased while achieving conducting the display scanning and touch sensing of the touch display panel (1) in a partitioned and synchronized manner.

### TECHNICAL FIELD

The present disclosure relates to the field of display technologies, and more particularly, to a driving method and apparatus for a touch display panel, and a touch display.

### BACKGROUND

In-cell touch technology is a screen bonding technique that represents the integration of a touch panel with a liquid crystal panel through a bonding process. In in-cell touch screens, ITO (indium tin metal oxide) electrodes can serve as common electrodes for display scanning (COM electrodes) or as touch sensing electrodes for touch sensing (sensor electrodes); time-division driven in-cell touch screens typically use the same layer of ITO electrodes for both display COM electrodes and touch sensor electrodes, preventing simultaneous display scanning and touch sensing. Display scanning and touch sensing need be carried out separately within a frame time to avoid mutual interference between display scanning and touch sensing. Due to the need for touch sensing to occupy a certain amount of time within a frame, the time available for display scanning in an in-cell touch screen driven by such method cannot be further increased, which can no longer meet the development trend of increasingly higher resolution and refresh rates of display screens.

Furthermore, in-cell touch screens with a full-time driving mode have been proposed, which typically involve dividing the display screen into multiple areas. The areas scanned by the gate signal lines are used for display scanning, with the ITO electrodes in these areas serving as COM electrodes for display scanning and being fed with COM signals. At the same time, other areas not scanned by the gate signal lines are used for touch sensing, with the ITO electrodes in these areas serving as sensor electrodes for touch sensing and being fed with TP signals. In this way, a portion of the display screen is used for display scanning, while another portion is used for touch sensing, thereby achieving full-time driving.

### SUMMARY

However, the current full-time driving mode does not provide a specific implementation scheme for performing display scanning on a portion of the in-cell touch screen while conducting touch sensing on another portion. It is unclear how to specifically carry out touch sensing on one area while performing display scanning on another area.

Therefore, it is necessary to propose a driving method and apparatus for a touch display panel, as well as a touch display device, to achieve a full-time driving mode for in-cell touch screens.

To address the aforementioned issue, the present disclosure provides embodiments of a driving method and apparatus for a touch display panel. It also discloses specific embodiments for performing touch sensing on a portion of the areas of an in-cell touch screen while simultaneously carrying out display scanning on another portion of the areas, thereby achieving a full-time driving mode for the in-cell touch screen.

According to a first aspect, an embodiment of the present disclosure provides a driving method for a touch display panel including N vertically arranged areas. The driving method includes:
under a condition that display scanning is performed on one of the areas, synchronously performing touch sensing on M areas out of the other N-1 areas in sequence, where 1≤MSN-1;
sequentially completing performing the display scanning and the touch sensing for all of the N areas within one frame time.

In some embodiments, an order in which the N areas undergo display scanning and touch sensing remains unchanged per frame time.

In some embodiments, durations of touch sensing for M areas out of the other N-1 areas are equal.

In some embodiments, under a condition that M is 1 or 2, one of the areas in which display scanning is conducted and M areas out of the other N-1 areas in which touch sensing is conducted are not adjacent to each other.

In some embodiments, the touch display panel includes a plurality of gate lines, a plurality of data lines, and conductive electrode arrays that are arranged in separate layers, where the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells; in the driving method, the display scanning being performed on one of the areas specifically includes:
outputting, by the gate lines, the scan signals to turn on any one or multiple rows of the pixel cells in the one of the areas, inputting, by the data lines, the data signals to the any one or multiple rows of the pixel cells in the one of the areas, and outputting, by the conductive electrode array in the one of the areas, the common signal.

In some embodiments, the performing touch sensing on M areas out of the other N-1 areas in sequence specifically includes:
outputting, by the conductive electrode arrays in M areas out of the N-1 areas, the touch signals.

According to a first aspect, an embodiment of the present disclosure provides a driving apparatus for a touch display panel including N vertically arranged areas. The driving apparatus includes a first synchronous touch module configured for:
under a condition that display scanning is performed on one of the areas, synchronously performing touch sensing on M areas out of the other N-1 areas in sequence, where 1≤M≤N-1;
sequentially completing performing the display scanning and the touch sensing for all of the N areas within one frame time.

In some embodiments, the touch display panel includes a plurality of gate lines, a plurality of data lines, and conductive electrode arrays that are arranged in separate layers, where the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells;
the first synchronous touch module of the driving apparatus includes an input/output module configured for under a condition that the display scanning is performed on one of the areas, causing the gate lines to output the scan signals to turn on any one or multiple rows of the pixel cells in the one of the areas, causing the data lines to input the data signals to the any one or multiple rows of the pixel cells in the one of the areas, and causing the conductive electrode array in the one of the areas to output the common signal.

In some embodiments, the first synchronous touch module of the driving apparatus further includes a second synchronous touch module, and the second synchronous touch module is configured for: under a condition that the touch sensing is performed on M areas out of the other N-1 areas in sequence, causing the conductive electrode arrays in M areas out of the N-1 areas to output the touch signals.

In some embodiments, an order in which the first synchronous touch module performs display scanning and touch sensing on the N areas remains unchanged per frame time.

In some embodiments, durations in which the first synchronous touch module performs touch sensing for M areas out of the other N-1 areas, respectively, are equal.

In some embodiments, under a condition that M is 1 or 2, the one of the areas and the M areas out of the other N-1 areas are not adjacent to each other.

According to a first aspect, an embodiment of the present disclosure provides a touch display. The touch display includes:
a touch display panel and a driving apparatus connected to each other, the driving apparatus configured for driving the touch display panel to display a screen;
where the touch display panel includes N vertically arranged areas, the driving apparatus includes a first synchronous touch module, and the first synchronous touch module is configured for:
under a condition that display scanning is performed on one of the areas, synchronously performing touch sensing on M areas out of the other N-1 areas in sequence, where 1≤M≤N-1;
sequentially completing performing the display scanning and the touch sensing for all of the N areas within one frame time.

In some embodiments, the touch display panel includes a plurality of gate lines, a plurality of data lines, and conductive electrode arrays that are arranged in separate layers, where the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells;
the first synchronous touch module of the driving apparatus includes an input/output module configured for under a condition that the display scanning is performed on one of the areas, causing the gate lines to output the scan signals to turn on any one or multiple rows of the pixel cells in the one of the areas, causing the data lines to input the data signals to the any one or multiple rows of the pixel cells in the one of the areas, and causing the conductive electrode array in the one of the areas to output the common signal.

In some embodiments, the first synchronous touch module of the driving apparatus further includes a second synchronous touch module, and the second synchronous touch module is configured for: under a condition that the touch sensing is performed on M areas out of the other N-1 areas in sequence, causing the conductive electrode arrays in M areas out of the N-1 areas to output the touch signals.

In some embodiments, an order in which the first synchronous touch module performs display scanning and touch sensing on the N areas remains unchanged per frame time.

In some embodiments, durations in which the first synchronous touch module performs touch sensing for M areas out of the other N-1 areas, respectively, are equal.

In some embodiments, under a condition that M is 1 or 2, the one of the areas and the M areas out of the other N-1 areas are not adjacent to each other.

### Beneficial Effect

The driving method and apparatus for a touch display panel, and the touch display provided in the embodiments of the present disclosure discloses a specific implementation scheme for performing display scanning on a portion of the touch display panel while synchronously conducting touch sensing on another portion, thus achieving a full-time driving mode for in-cell touch screens. Moreover, by adjusting the relationship between the number of areas for each display scanning and the number of areas for each touch sensing, the relationship between the display scanning refresh rate and the touch sensing refresh rate may be controlled, enabling the touch sensing refresh rate to be several times the display scanning refresh rate. Thereby, the sampling frequency and sensing speed of touch sensing are increased while achieving conducting the display scanning and touch sensing of the touch display panel in a partitioned and synchronized manner

### BRIEF DESCRIPTION OF THE DRAWINGS

FIG. 1 is a schematic flowchart of a driving method for a touch display panel according to an embodiment of the present disclosure;

FIG. 2 is a schematic diagram of partition of a touch display panel according to an embodiment of the present disclosure;

FIG. 3 is a schematic diagram of a structure of a display panel according to an embodiment of the present disclosure;

FIG. 4 is a schematic diagram of a spatial distribution of a first type of display scanning and touch sensing of a touch display panel being conducted in a partitioned and synchronized manner according to an embodiment of the present disclosure;

FIG. 5 is a timing diagram of the scan signal and the touch signal in FIG. 4;

FIG. 6 is a schematic diagram of a spatial distribution of a second type of display scanning and touch sensing of a touch display panel being conducted in a partitioned and synchronized manner according to an embodiment of the present disclosure;

FIG. 7 is a timing diagram of the scan signal and the touch signal in FIG. 6;

FIG. 8 is a schematic diagram of a spatial distribution of a third type of display scanning and touch sensing of a touch display panel being conducted in a partitioned and synchronized manner according to an embodiment of the present disclosure;

FIG. 9 is a timing diagram of the scan signal and the touch signal in FIG. 8;

FIG. 10 is a schematic diagram of a structure of a touch display according to an embodiment of the present disclosure.

### DETAILED DESCRIPTION

In order that the objects, technical solutions, and effects of the present disclosure may be made clearer and more explicit, the present disclosure will be described in further detail below with reference to the accompanying drawings and embodiments. It is to be understood that the specific embodiments described herein are merely illustrative of the present disclosure and are not intended to limit the present disclosure.

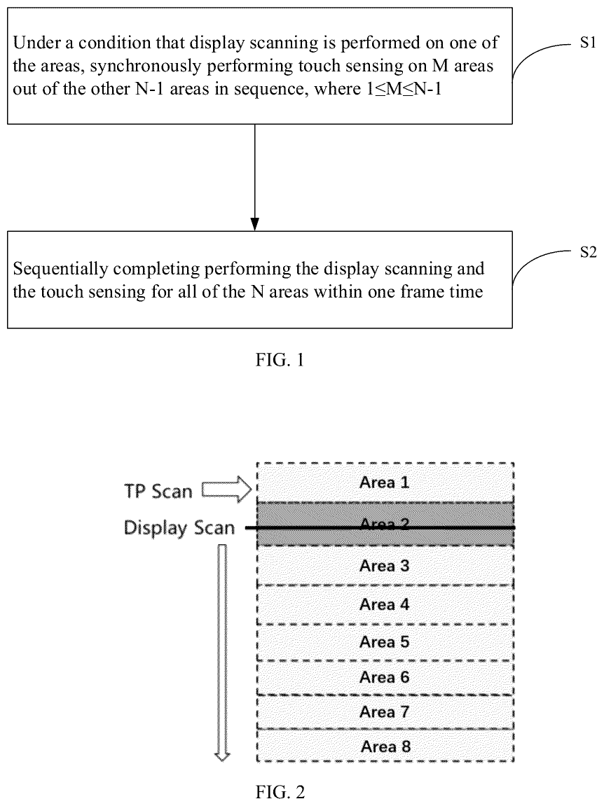

To realize a full-time driving mode of an in-cell touch screen, an embodiment of the present disclosure provides a driving method for a touch display panel. As shown in FIG. 1, the touch display panel includes N vertically arranged areas, and the driving method includes the following steps S1 and S2.
Step S1: Under a condition that display scanning is performed on one of the areas, synchronously performing touch sensing on M areas out of the other N-1 areas in sequence, where 1≤M≤N-1;
Step S2: Sequentially completing performing the display scanning and the touch sensing for all of the N areas within one frame time.

Specifically, for the N vertically arranged areas of the touch display panel, when display scanning is performed on one area, touch sensing is synchronously carried out on M areas out of the other N-1 areas in sequence. Thus, within one frame time, display scanning and touch sensing are conducted for all N areas, thereby completing the display scanning and touch sensing of the touch display panel in a partitioned and synchronized manner.

Here, M and N are fixed values, meaning that N is the predetermined number of areas into which the touch display panel is divided; M is the predetermined number of areas for touch sensing when display scanning is performed on one area. Additionally, the one area among the N areas where display scanning is performed each time is different, and the M areas out of the other N-1 areas where touch sensing is synchronously carried out are also different. That is, within one frame time, each area is subjected to only one display scanning and one touch sensing, without repeating the display scanning and touch sensing for an area.

For example, as shown in FIG. 2, if N=8 and M=1, the touch display panel is divided into 8 vertically arranged areas, namely Area 1, Area 2, . . . , Area 8. When display scanning is performed on Area 2, touch sensing (a.k.a. TP Scan) is synchronously conducted on Area 1, followed by display scanning on Area 3 while touch sensing synchronously being performed on Area 2, and so on so forth. Within one frame time, display scanning and touch sensing are completed for Area 1 through Area 8.

The driving method for the touch display panel provided in the embodiment of the present disclosure discloses a specific implementation scheme for performing display scanning on a portion of the touch display panel while synchronously conducting touch sensing on another portion, thus achieving a full-time driving mode for in-cell touch screens. Moreover, by adjusting the relationship between the number of areas for each display scanning and the number of areas for each touch sensing, the relationship between the display scanning refresh rate and the touch sensing refresh rate may be controlled, enabling the touch sensing refresh rate to be several times that of the display scanning refresh rate. Thereby, the sampling frequency and sensing speed of touch sensing are increased while achieving conducting the display scanning and touch sensing of the touch display panel in a partitioned and synchronized manner.

It should be noted that the order in which the N areas undergo display scanning and touch sensing remains unchanged per frame time. That is, within each frame time, display scanning is performed on each area in a fixed sequence, and touch sensing is simultaneously conducted on M areas out of the other N-1 areas in turn, thereby conducting both display scanning and touch sensing for the N areas to complete the display scanning and touch sensing of the touch display panel in a partitioned and synchronized manner.

It should also be noted that the durations of touch sensing for M areas out of the other N-1 areas are equal. That is, while display scanning is performed on one area, touch sensing is conducted on the other M areas for an equal duration, meaning that touch sensing is carried out for each of the M areas for the same length of time.

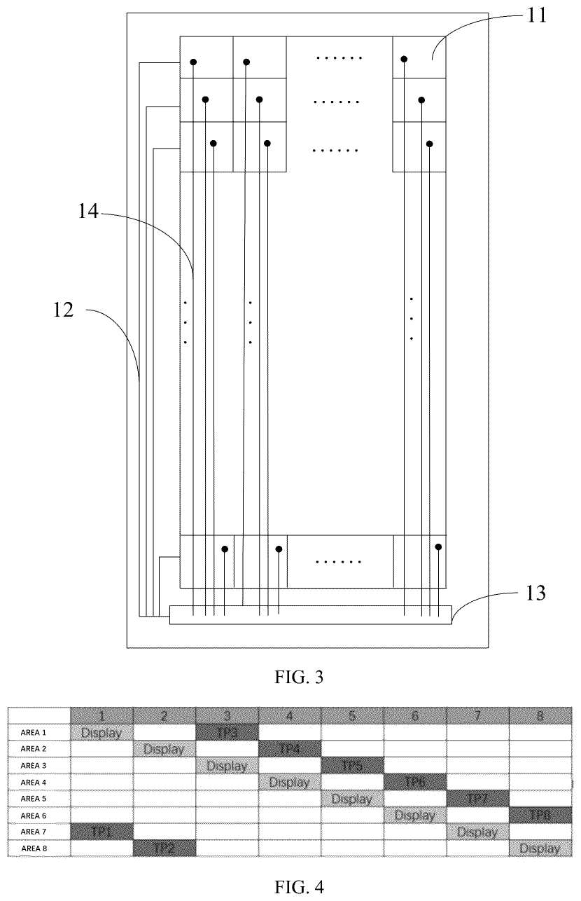

Based on the embodiment described above, FIG. 3 is a schematic diagram of a structure of a display panel according to an embodiment of the present disclosure. As shown in FIG. 3, the ITO electrodes in the touch display panel are divided into multiple conductive electrodes to form conductive electrode arrays. Each conductive electrode 11 is connected to an external chip 13 via a conductive wire 14, one of the N areas of the touch display panel being a display area, and M areas out of the other N-1 areas being touch sensing areas.

As shown in conjunction with FIGS. 1, 2, and 3, the touch display panel includes a plurality of gate lines 12, a plurality of data lines (not shown in the figure), and conductive electrode arrays that are arranged in separate layers, where the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells. In the driving method, the display scanning being performed on one of the areas specifically includes the following.

Outputting, by the gate lines, the scan signals to turn on any one or multiple rows of the pixel cells in the one of the areas, inputting, by the data lines, the data signals to the any one or multiple rows of the pixel cells in the one of the areas, and outputting, by the conductive electrode array in the one of the areas, the common signal.

Furthermore, in the driving method, the performing touch sensing on M areas out of the other N-1 areas in sequence specifically includes the following.

Outputting, by the conductive electrode arrays in M areas out of the N-1 areas, the touch signals.

Specifically, when display scanning is performed on one of the areas, the gate lines output the scan signals to the pixel cells in the one of the areas, the data lines output the data signals to the pixel cells in the one of the areas, and the conductive electrode array of the one of the areas inputs the common signal from the external chip through the conductive wires, so that the pixel cells in the one of the areas are turned on by the scan signals, and display a predetermined image utilizing the data signals and the common signal. When touch sensing is performed on M areas out of the other N-1 areas, the conductive electrode arrays in the M areas input the touch signals from the external chip through conductive wires, thereby causing the M areas to perform touch sensing.

It should be noted that although the display scanning and the touch sensing are performed in a partitioned synchronous manner, there may still be a capacitive coupling effect between the area of the display scanning and the area of the touch sensing. For example, when the touch sensing is performed on Area 1 as shown in FIG. 2, and the display scanning is performed on Area 2 in a synchronous manner, there is a capacitive coupling effect between Area 1 and Area 2, resulting in interference between the two areas, which may affect the display effect of the touch display panel. Therefore, when M is 1 or 2, it is possible to arrange that one of the areas in which display scanning is conducted and M areas out of the other N-1 areas in which touch sensing is conducted are not adjacent to each other. This configuration aims to minimize interference between the area conducting display scanning and the area(s) conducting touch sensing in a touch display panel that operates with a full-time driving mode. For details, refer to the following detailed description of each embodiment.

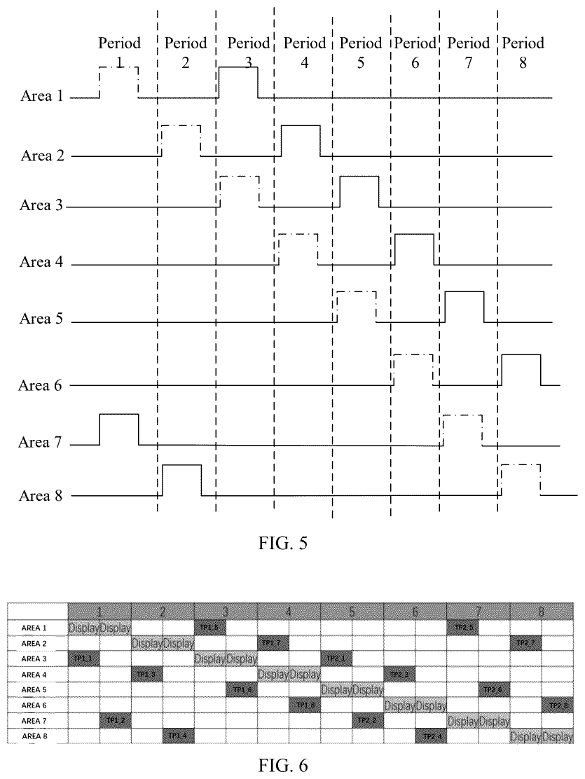

Based on the aforementioned embodiments, as shown in FIGS. 4 to 9, taking N=8 as an example, the horizontal headings represent time period 1, time period 2, . . . , time period 8, and the vertical headings represent area 1, area 2, . . . , area 8. The following describes the full-time scanning process of the touch display panel when M is 1, 2, or 3. Within one frame time, the order of display scanning is always area 1→area 2→area 3→area 4→area 5→area 6→area 7→area 8, and the scanning signals for the 8 areas are represented by “Display.” Additionally, in FIG. 4, the touch signals are sequentially represented by TP1, TP2, . . . , TP8; in FIG. 6, the touch signals are sequentially represented by TP1_1, TP1_2, . . . , TP1_8, TP2_1, TP2_2, . . . , TP2_8, TP3_1, TP3_2, . . . , TP3_8; in FIG. 8, the touch signals are not specifically identified in English, but are represented by black blocks; in FIGS. 5, 7, and 9, the dashed pulses represent scanning signals, and the solid pulses represent touch signals.

As shown in FIGS. 4 and 5, when M=1, within one frame time, the touch sensing sequence may cycle through areas 7→8→1→2→3→4→5→6 once, thus making the touch sensing refresh rate the same as the display scanning refresh rate. It can be seen that one of the areas conducting display scanning and one of the areas conducting touch sensing are not adjacent, thereby reducing interference between the area conducting display scanning and the area conducting touch sensing.

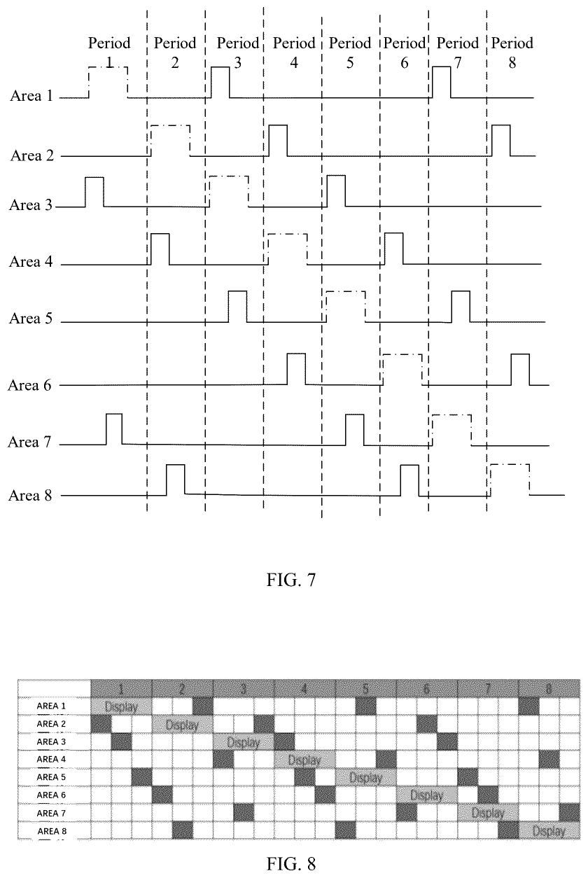

As shown in FIGS. 6 and 7, when M=2, within one frame time, the touch sensing sequence may cycle through areas 3→7→4→8→1→5→2→6 twice, with each area taking the same amount of time, thus doubling the touch sensing refresh rate in comparison to the display scanning refresh rate, increasing the touch sensing sampling frequency to twice that of display scanning. It can be seen that one of the areas conducting display scanning and two of the areas conducting touch sensing are not adjacent, thereby reducing interference between the area conducting display scanning and those conducting touch sensing.

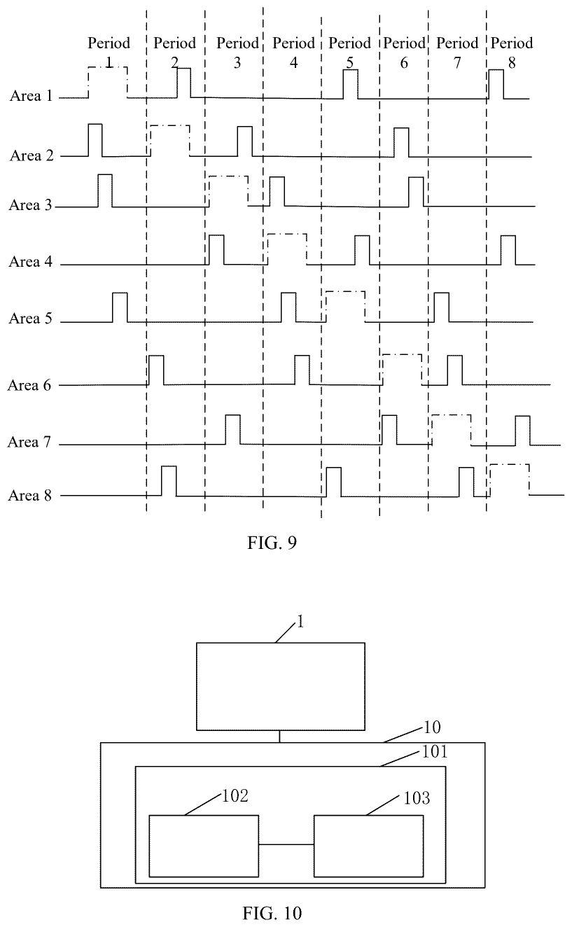

As shown in FIGS. 8 and 9, when M=3, within one frame time, the touch sensing sequence may cycle through areas 2→3→5→6→8→1→4→7 three times, with each area taking the same amount of time, thus tripling the touch sensing refresh rate in comparison to the display scanning refresh rate, increasing the touch sensing sampling frequency to three times that of display scanning.

It should be noted that when the touch sensing refresh rate exceeds three times the display scanning refresh rate, it is necessary to increase the number of partitions for touch sensing corresponding to each row of display scanning, thereby increasing the touch sensing refresh rate, to enhance the sampling frequency and sensing speed of touch sensing.

It will be appreciated that the area order of touch sensing in the full-time scanning process of the touch display panel when N=8, M=1, 2, or 3, as described above, is merely exemplary, and is not limited to the aforementioned order, and further elaboration is not provided here.

Based on the above embodiments, as shown in FIG. 10, an embodiment of the present disclosure further provides a driving apparatus 10 for a touch display panel 1, where the touch display panel includes N vertically arranged areas, the driving apparatus 10 includes a first synchronous touch module 101, and the first synchronous touch module 101 is configured for:
Under a condition that display scanning is performed on one of the areas, synchronously performing touch sensing on M areas out of the other N-1 areas in sequence, where 1≤M≤N-1;
Sequentially completing performing the display scanning and the touch sensing for all of the N areas within one frame time.

A first synchronous touch module 101 of a driving apparatus 10 for a touch display panel provided in the embodiment of the present disclosure discloses a specific implementation scheme for performing display scanning on a portion of the touch display panel while synchronously conducting touch sensing on another portion, thus achieving a full-time driving mode for in-cell touch screens. Moreover, by adjusting the relationship between the number of areas for each display scanning and the number of areas for each touch sensing, the relationship between the display scanning refresh rate and the touch sensing refresh rate may be controlled, enabling the touch sensing refresh rate to be several times that of the display scanning refresh rate, thereby achieving conducting the scanning and driving of the touch display panel in a partitioned and synchronized manner, and improving the sampling frequency and sensing speed of touch sensing.

In some embodiments, the touch display panel includes a plurality of gate lines, a plurality of data lines, and conductive electrode arrays that are arranged in separate layers, the plurality of gate lines and the plurality of data lines being arranged in a crisscross pattern to form a plurality of pixel cells, the gate lines configured to output scan signals to turn on the pixel cells, the data lines configured to input data signals to the pixel cells, and the conductive electrode arrays configured to output a common signal or touch signals. The first synchronous touch module 101 of the driving apparatus 10 includes an input/output module 102 configured for: under a condition that the display scanning is performed on one of the areas, causing the gate lines to output the scan signals to turn on any one or multiple rows of the pixel cells in the one of the areas, causing the data lines to input the data signals to the any one or multiple rows of the pixel cells in the one of the areas, and causing the conductive electrode array in the one of the areas to output the common signal.

In some embodiments, the first synchronous touch module 101 of the driving apparatus 10 further includes a second synchronous touch module 103, which is configured for: under a condition that the touch sensing is performed on M areas out of the other N-1 areas in sequence, causing the conductive electrode arrays in M areas out of the N-1 areas to output the touch signals.

Based on the above embodiments, as shown in FIG. 10, an embodiment of the present disclosure further provides a touch display including:
A touch display panel 1 and a driving apparatus 10 connected to each other, the driving apparatus 10 configured for driving the touch display panel 1 to display screen;
Where the touch display panel includes N vertically arranged areas, the driving apparatus 10 includes a first synchronous touch module 101, and the first synchronous touch module 101 is configured for:
Under a condition that display scanning is performed on one of the areas, synchronously performing touch sensing on M areas out of the other N-1 areas in sequence, where 1≤M≤N-1;
Sequentially completing performing the display scanning and the touch sensing for all of the N areas within one frame time.

In some embodiments, the touch display panel includes a plurality of gate lines, a plurality of data lines, and conductive electrode arrays that are arranged in separate layers, the plurality of gate lines and the plurality of data lines being arranged in a crisscross pattern to form a plurality of pixel cells, the gate lines configured to output scan signals to turn on the pixel cells, the data lines configured to input data signals to the pixel cells, and the conductive electrode arrays configured to output a common signal or touch signals. The first synchronous touch module 101 of the driving apparatus 10 includes an input/output module 102 configured for: under a condition that the display scanning is performed on one of the areas, causing the gate lines to output the scan signals to turn on any one or multiple rows of the pixel cells in the one of the areas, causing the data lines to input the data signals to the any one or multiple rows of the pixel cells in the one of the areas, and causing the conductive electrode array in the one of the areas to output the common signal.

In some embodiments, the first synchronous touch module 101 of the driving apparatus 10 further includes a second synchronous touch module 103, which is configured for: under a condition that the touch sensing is synchronously performed on M areas out of the other N-1 areas in sequence, causing the conductive electrode arrays in M areas out of the N-1 areas to output the touch signals.

In some embodiments, the driving apparatus includes a timing controller (not shown in the figure) that controls the gate lines to output the scan signals, the data lines to output the data signals, and the conductive electrode arrays to output the common signal or touch signals.

It will be appreciated by a person of ordinary skill in the art that equivalent substitutions or modifications can be made based on the technical solution and inventive concept of the present disclosure, and all such modifications or substitutions should fall within the scope of the claims appended to the present disclosure.

1. A driving method for a touch display panel including N vertically arranged areas, wherein the driving method comprises:
under a condition that display scanning is performed on one of the areas, synchronously performing touch sensing on M areas out of the other N-1 areas in sequence, wherein 1≤M≤N-1;
sequentially completing performing the display scanning and the touch sensing for all of the N areas within one frame time.

2. The driving method for a touch display panel according to claim 1, wherein an order in which the N areas undergo display scanning and touch sensing remains unchanged per frame time.

3. The driving method for a touch display panel according to claim 1, wherein durations of touch sensing for M areas out of the other N-1 areas are equal.

4. The driving method for a touch display panel according to claim 1, wherein under a condition that M is 1 or 2, one of the areas in which display scanning is conducted and M areas out of the other N-1 areas in which touch sensing is conducted are not adjacent to each other.

5. The driving method for a touch display panel according to claim 1, wherein the touch display panel includes a plurality of gate lines, a plurality of data lines, and conductive electrode arrays that are arranged in separate layers, wherein the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells; in the driving method, the display scanning being performed on one of the areas specifically comprises:
outputting, by the gate lines, the scan signals to turn on any one or multiple rows of the pixel cells in the one of the areas, inputting, by the data lines, the data signals to the any one or multiple rows of the pixel cells in the one of the areas, and outputting, by the conductive electrode array in the one of the areas, the common signal.

6. The driving method for a touch display panel according to claim 5, wherein the performing touch sensing on M areas out of the other N-1 areas in sequence specifically comprises:
outputting, by the conductive electrode arrays in M areas out of the N-1 areas, the touch signals.

7. A driving apparatus for a touch display panel including N vertically arranged areas, wherein the driving apparatus includes a first synchronous touch module configured for:
under a condition that display scanning is performed on one of the areas, synchronously performing touch sensing on M areas out of the other N-1 areas in sequence, where 1≤M<N-1;
sequentially completing performing the display scanning and the touch sensing for all of the N areas within one frame time.

8. The driving apparatus for a touch display panel according to claim 7, wherein the touch display panel includes a plurality of gate lines, a plurality of data lines, and conductive electrode arrays that are arranged in separate layers, wherein the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells;
the first synchronous touch module of the driving apparatus includes an input/output module configured for under a condition that the display scanning is performed on one of the areas, causing the gate lines to output the scan signals to turn on any one or multiple rows of the pixel cells in the one of the areas, causing the data lines to input the data signals to the any one or multiple rows of the pixel cells in the one of the areas, and causing the conductive electrode array in the one of the areas to output the common signal.

9. The driving apparatus for a touch display panel according to claim 8, wherein the first synchronous touch module of the driving apparatus further comprises a second synchronous touch module, and the second synchronous touch module is configured for: under a condition that the touch sensing is performed on M areas out of the other N-1 areas in sequence, causing the conductive electrode arrays in M areas out of the N-1 areas to output the touch signals.

10. The driving apparatus for a touch display panel according to claim 7, wherein an order in which the first synchronous touch module performs display scanning and touch sensing on the N areas remains unchanged per frame time.

11. The driving apparatus for a touch display panel according to claim 7, wherein durations in which the first synchronous touch module performs touch sensing for M areas out of the other N-1 areas, respectively, are equal.

12. The driving apparatus for a touch display panel according to claim 7, wherein under a condition that M is 1 or 2, the one of the areas and the M areas out of the other N-1 areas are not adjacent to each other.

13. A touch display comprising:
a touch display panel and a driving apparatus connected to each other, the driving apparatus configured for driving the touch display panel to display a screen;
wherein the touch display panel includes N vertically arranged areas, the driving apparatus includes a first synchronous touch module, and the first synchronous touch module is configured for:
under a condition that display scanning is performed on one of the areas, synchronously performing touch sensing on M areas out of the other N-1 areas in sequence, where 1≤M≤N-1;
sequentially completing performing the display scanning and the touch sensing for all of the N areas within one frame time.

14. The touch display according to claim 13, wherein the touch display panel includes a plurality of gate lines, a plurality of data lines, and conductive electrode arrays that are arranged in separate layers, wherein the plurality of gate lines and the plurality of data lines are arranged in a crisscross pattern to form a plurality of pixel cells, the gate lines are configured to output scan signals to turn on the pixel cells, the data lines are configured to input data signals to the pixel cells, and the conductive electrode arrays are configured to output a common signal or touch signals to the pixel cells;
the first synchronous touch module of the driving apparatus includes an input/output module configured for under a condition that the display scanning is performed on one of the areas, causing the gate lines to output the scan signals to turn on any one or multiple rows of the pixel cells in the one of the areas, causing the data lines to input the data signals to the any one or multiple rows of the pixel cells in the one of the areas, and causing the conductive electrode array in the one of the areas to output the common signal.

15. The touch display according to claim 14, wherein the first synchronous touch module of the driving apparatus further comprises a second synchronous touch module, and the second synchronous touch module is configured for: under a condition that the touch sensing is performed on M areas out of the other N-1 areas in sequence, causing the conductive electrode arrays in M areas out of the N-1 areas to output the touch signals.

16. The touch display according to claim 13, wherein an order in which the first synchronous touch module performs display scanning and touch sensing on the N areas remains unchanged per frame time.

17. The touch display according to claim 13, wherein durations in which the first synchronous touch module performs touch sensing for M areas out of the other N-1 areas, respectively, are equal.

18. The touch display according to claim 13, wherein under a condition that M is 1 or 2, the one of the areas and the M areas out of the other N-1 areas are not adjacent to each other.

19. The driving method for a touch display panel according to claim 1, wherein the one area among the N areas where display scanning is performed each time is different, and the M areas out of the other N-1 areas where touch sensing is synchronously carried out are also different.

20. The driving apparatus for a touch display panel according to claim 7, wherein the one area among the N areas where display scanning is performed each time is different, and the M areas out of the other N-1 areas where touch sensing is synchronously carried out are also different.
